(19) United States
(12) Patent Application Publication
(10) Pub. No.: US 2024/0142060 A1
(43) Pub. Date: May 2, 2024

(54) Tank Monitoring Systems And Methods

(71) Applicant: University of Alaska - Fairbanks, Fairbanks, AK (US)

(72) Inventors: Robert Bensin, Fairbanks, AK (US); William Thomson, Fairbanks, AK (US)

(21) Appl. No.: 18/497,460

(22) Filed: Oct. 30, 2023

Related U.S. Application Data
(60) Provisional application No. 63/420,292, filed on Oct. 28, 2022.

(51) Int. Cl. F17C 13/02; F17C 13/04

(52) U.S. Cl. CPC F17C 13/02; F17C 13/04; F17C 2250/032; F17C 2250/043; F17C 2250/0636

(57) ABSTRACT

A system has a gas supply and at least one tank defining an interior. A first port is positioned within the interior of each tank of the at least one tank and is in selective fluid communication with the gas supply. A conduit extends between and provides fluid communication between the gas supply and the first port. A first valve is fluidly positioned between the gas supply and the first port. The first valve is configured to selectively permit fluid communication between the gas supply and the first port. A pressure sensor is in fluid communication with the conduit. The computing device is configured to: cause the first valve to open, receive a first signal from the pressure sensor indicative of pressure within the conduit, and determine a quantity of fluid in the tank based on the first signal from the pressure sensor.

### CROSS-REFERENCE TO RELATED APPLICATION

This application claims priority to and the benefit of the filing date of U.S. Provisional Application No. 63/420,292, filed Oct. 28, 2022, the entirety of which is hereby incorporated by reference herein.

### FIELD

This disclosure relates to monitoring tanks such as, for example, fuel tanks.

### BACKGROUND

Monitoring the levels and contents of tanks is important across various applications. For example, in the field of fuel tanks, a typical fuel farm can have on the order of ten or twenty tanks. A typical system for monitoring a few tanks costs tens of thousands of dollars. The major cost is associated with the sensors. Sensor cost is even higher for taller tanks. The sensors typically used are of a magnetostrictive design using multiple floats which can detect water and fuel density as well. Usually not all tanks are monitored due to the cost of sensors and their install. With lack of reliable level sensing, tank dipping by hand is often done to verify inventory.

Accordingly, it is desirable to provide a robust and economical solution for monitoring tanks and the contents therein.

### SUMMARY

Described herein, in various aspects, is a system comprising at least one tank defining an interior. The system further comprises a gas supply. A first port is positioned within the interior of each tank of the at least one tank. The first port is in selective fluid communication with the gas supply. A conduit extends between and provides fluid communication between the gas supply and the first port. A first valve is fluidly positioned between the gas supply and the first port. The first valve is configured to selectively permit fluid communication between the gas supply and the first port. A pressure sensor is in fluid communication with the conduit. A computing device is in electronic communication with the pressure sensor and the first valve. The computing device is configured to: cause the first valve to open, receive a first signal from the pressure sensor indicative of pressure within the conduit, and determine a quantity of fluid in the tank based on the first signal from the pressure sensor.

In another aspect, a method comprises supplying, through a conduit, a gas to a first port submerged in a liquid within an interior of a first tank. A first pressure measurement is received. At least one of a quantity of the liquid or an error condition is determined based on the first pressure measurement.

Additional advantages of the disclosed systems and methods will be set forth in part in the description that follows, and in part will be obvious from the description, or may be learned by practice of the claimed invention. The advantages of the disclosed systems and methods will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 is a schematic diagram of an exemplary system for monitoring tanks as disclosed herein.

FIG. 2 illustrates a pneumatic system of the system for monitoring tanks as disclosed herein.

FIG. 3 is a block diagram of a computing environment comprising a computing device as disclosed herein.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

It must be noted that as used herein and in the appended claims, the singular forms “a,” “an,” and “the” include plural references unless the context clearly dictates otherwise. Thus, for example, unless the context dictates otherwise, reference to “a port” provides disclosure of embodiments in which only a single such port is provided, as well as embodiments in which a plurality of such ports are provided.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, in some optional aspects, when values are approximated by use of the terms “substantially” or “generally,” it is contemplated that values within up to 15%, up to 10%, up to 5%, or up to 1% (above or below) of the particular value can be included within the scope of those aspects. When used with respect to an identified property or circumstance, “substantially” or “generally” can refer to a degree of deviation that is sufficiently small so as to not measurably detract from the identified property or circumstance, and the exact degree of deviation allowable may in some cases depend on the specific context.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of” For example, “at least one of A, B and C” explicitly includes only A, only B, only C, and combinations of each.

As used herein “or” should be understood to be an inclusive or unless context dictates otherwise. For example, when separating items in a list, “or” should be interpreted as being inclusive, i.e., the inclusion of at least one, but also including more than one, of a number or list of elements, and, optionally, additional unlisted items. In other aspects, the term “or” can refer to only a single element of a list of elements.

As disclosed herein, a tank can include any vessel configured to contain fluid therein. The tank can be fluidly sealed or vented to the environment. The fluid can be, at least when contained in the tank, a liquid.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

As used herein, “first,” “second,” “third,” etc. are used to distinguish different elements. It should be understood that, in different aspects, the system may or may not have all of the different elements. For example, in some exemplary aspects, the system can have a “first port” and a “third port,” but no “second port.”

Disclosed herein are systems and methods for monitoring tanks, such as fuel tanks.

The system can provide both local and remote monitoring of tanks and the contents therein. The system can use level bubblers to detect properties of a liquid within a tank, such as quantity and density. The level bubbler can force a gas out of a port (e.g., an opening of a dip tube) that is submerged in liquid within the tank. A back pressure can be measured. With the density of the liquid known, the level can be calculated using the back pressure and density. A computing device (e.g., a controller) can receive signals from a pressure transmitter and determine the back pressure from the signals to determine the level of the liquid within the tank.

The disclosed systems and methods for monitoring tanks can be suitable for an exemplary fuel farm having any number of fuel tanks, including from about a dozen tanks to about twenty tanks. Tanks can be a mix of different styles, particularly horizontal and vertical cylindrical. Tanks may be at different base elevations and have different heights. In the exemplary fuel farm, some (optionally, most or all) tanks can contain diesel and can be vented to atmosphere. Some tanks can be sealed with pressure relief vents, particularly gasoline tanks. Delivered fuel can have different densities from one fill to the next. Sometimes contaminating water can be included in the delivery. Tanks tend to be smaller in remote areas and can be smaller than typical petroleum company farms. Hence using inexpensive sensors is more important. The monitoring system can be effective across a wide temperature range (e.g., from −40° C. to +60° C.).

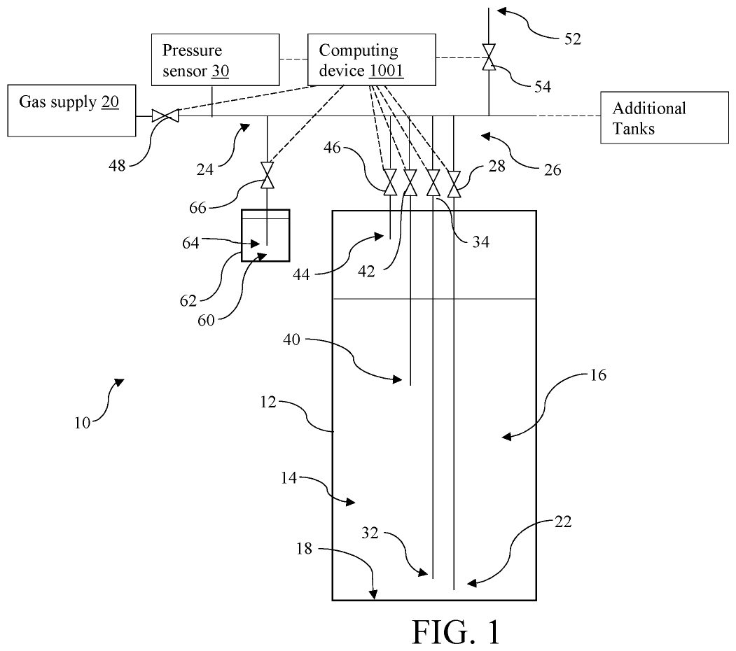

Referring to FIG. 1, a system 10 can comprise at least one tank 12 defining an interior 14. Optionally, the at least one tank 12 can comprise a plurality of tanks 12. However, in other embodiments, the at least one tank 12 can consist of a single tank. A fluid 16 can be contained within the interior of each tank 12. The fluid 16 can be a liquid when contained in the tank. In some optional aspects, the fluid 16 can be, for example, fuel, such as gasoline or diesel.

The system 10 can comprise a gas supply 20. The gas supply 20 can comprise, for example, air or bottled nitrogen. For example, in aspects in which the gas supply 20 comprises air, the gas supply can further comprise a pump, a filter, and a dryer (e.g., a silica gel drier) that is configured to remove moisture from the air. In further aspects, in which the gas supply comprises nitrogen, the gas supply can further comprise a pressure regulator and a filter.

A respective first port 22 can be positioned within the interior 14 of each tank 12 of the at least one tank.

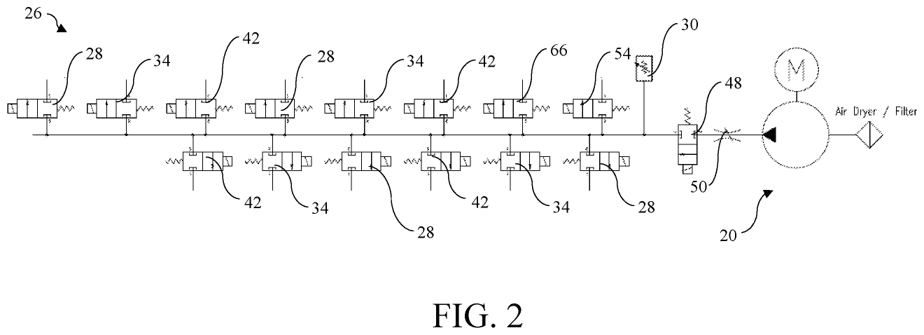

A conduit 24 can provide fluid communication between the gas supply and each respective first port 22. The conduit 24 can comprise, for example, pipe or tubing. In exemplary aspects, the conduit 24 can comprise a manifold 26 (FIGS. 1 and 2) that is configured to distribute the gas supply 20 throughout the system 10.

The first port 22 can be in selective fluid communication with the gas supply 20. A first valve 28 can be fluidly positioned between the gas supply 20 and the first port 22 (e.g., in fluid communication with both the gas supply 20 and the first port 22). The first valve 28 can be configured to selectively permit (e.g., selectively open to permit) fluid communication between the gas supply 20 and the first port 22. The first port 22 can be positioned proximate to a bottom 18 of the tank 12. In this way, the first port 22 can be submerged in the fluid 16 unless tank is essentially or substantially empty. In exemplary aspects, the first port can be no greater than 5 inches, or no greater than 3 inches, or about 1 inch from the bottom 18 of the tank.

A pressure sensor 30 can be in fluid communication with the conduit 24. Thus, the pressure sensor 30 can be configured to determine a pressure within the conduit 24.

A computing device 1001 can be in communication (e.g., electronic or electrical communication) with the pressure sensor 30 and the first valve 28. The computing device 1001 can be configured to cause the first valve to open, and receive a first signal from the pressure sensor indicative of pressure within the conduit. Based on the first signal from the pressure sensor 30, the computing device 1001 can be configured to determine a quantity of fluid in the tank. The quantity of liquid can be determined as a height of fluid within the tank, a mass, a volume, a ratio of fluid in the tank to a maximum capacity, etc. For example, a pressure difference between ambient pressure and the pressure at the first port can be used to determine a height of liquid above the first port according to the formula ΔP/(μg)=h, wherein ΔP is a pressure differential, p is the density of the fluid 16, and g is the acceleration due to gravity (e.g., 9.81 m/s/s at sea level). In some aspects, density of the fluid can be known or assumed. In further aspects, the density of the fluid can be determined as further disclosed herein.

In some aspects, the system 10 can be configured to determine a density of the fluid 16 in one or more of the tanks 12 in order to determine presence of water in the fluid. The system 10 can comprise a respective second port 32 positioned within the interior of one or more of the tanks 12. The second port 32 can be in selective fluid communication with the gas supply 20. The second port 32 can be vertically spaced from the first port (e.g., by less than 5 inches, or less than 3 inches, or from about one inch to about two inches). A second valve 34 can be fluidly positioned between the gas supply 20 and the second port 32 (e.g., in fluid communication with both the gas supply 20 and the second port 32). The second valve 34 can be configured to selectively permit (e.g., selectively open to permit) fluid communication between the gas supply 20 and the second port 32. The computing device 1001 can be configured to cause the second valve to open and receive a second signal from the pressure sensor 30 indicative of pressure within the conduit 24. The computing device 1001 can further be configured to compare the first and second signals from the pressure sensor to determine a presence of water in the respective tank. For example, given the known vertical spacing between the first and second ports, a density of the fluid can be determined from a pressure difference between the first and second ports. For example, density can be calculated according to the formula ρ=ΔP/(h₁₋₂g), where h₁₋₂ is the spacing between the first and second ports 22, 32. Water can cause the fluid to be irregularly dense, indicating water mixed in with the fuel. The computing device 1001 can further be configured to cause an alarm upon determining that the density of the fluid is beyond a threshold.

In some aspects, the system 10 can be configured to determine a density of the fluid 16 in order to provide a more accurately measured quantity (e.g., volume) of fluid. For example, it is contemplated that fuel density can vary, and determining the exact density of the fuel can allow the exact density to be factored into the fuel quantity determination.

In these aspects, a respective third port 40 positioned within the interior 16 of one or more of the tanks 12. The third port 40 can be in selective fluid communication with the gas supply 20. The third port 40 can be vertically spaced from the first port. For example, the third port can be vertically spaced from the first port by a known distance (e.g., from about one foot to about five feet, or from about two feet to about four feet). A third valve 42 can be fluidly positioned between the gas supply 20 and the third port 40 (e.g., in fluid communication with the gas supply 20 and the third port 40). The third valve 42 can be configured to selectively permit (e.g., selectively open to permit) fluid communication between the gas supply 20 and the third port 40.

The computing device 1001 can be further configured to cause the third valve 42 to open and receive a third signal from the pressure sensor 30 indicative of pressure within the conduit 24. The computing device 1001 can compare the first and third signals from the pressure sensor 30 to determine a density of fluid in the at least one tank. For example, density can be calculated according to the formula ΔP/(h₁₋₃g)=ρ, where h₁₋₃ is the spacing between the first and third ports 22, 40. The computing device 1001 can be configured to determine the quantity (e.g., volume) of fluid in the tank 12 based on the density of the at least one fluid determined by the computing device based on the first and third signals from the pressure sensor. It is contemplated that the density of the fluid need not be checked as frequently as other measurements (e.g., fluid level). Previous fluid measurements can typically be used, especially if pressure measurements indicate that the fluid level is below the third port 40.

It can be desirable to determine a gas pressure at a top of the tank above the liquid within the tank. For example, for a fluidly sealed tank, a pressure or a vacuum can be measured. The pressure or vacuum in the tank can be indicative of, for example, a leak. Accordingly, in some optional aspects, a fourth port 44 can be positioned within the interior 14 of one or more of the tanks 12. A fourth valve 46 can be fluidly positioned between the pressure sensor 30 and the fourth port 44 (e.g., in fluid communication with both the pressure sensor 30 and the fourth port 44). The fourth valve 46 can be configured to selectively permit (e.g., selectively open to permit) fluid communication between the pressure sensor 30 and the fourth port 44. The computing device 1001 can be configured to cause the fourth valve 46 to open and can receive a fourth signal from the pressure sensor 30 indicative of pressure within the conduit 24. The computing device 1001 can determine a presence of a gas leak based on the fourth signal from the pressure sensor. For example, in some aspects, the gas leak can be determined based on a comparison of the measurement from the pressure sensor to a previous measurement, wherein a pressure drop over time is indicative of a leak. In another aspect, in some aspects, the gas leak can be determined based on a comparison of the measurement from the pressure sensor to a barometric pressure or a pre-programmed threshold.

In some aspects, the system 10 can comprise a main gas supply valve 48 that is configured to inhibit flow between the supply gas 20 and the manifold 26. Thus, the main gas supply valve 48 can be configured to selectively inhibit fluid communication from the supply gas 20 to every port (e.g., the first, second, third, and fourth ports 22, 32, 40, 44). The main gas supply valve 48 can be closed to permit measurement of barometric pressure as further disclosed herein.

The system 10 can further comprise a check valve 50 (FIG. 2) that is configured to inhibit flow from the manifold 26 to the supply gas 20.

The system 10 can comprise a barometric pressure port 52 open to ambient environment. A barometric pressure valve 54 (e.g., a solenoid valve) can be fluidly positioned between the pressure sensor 30 and the barometric pressure port 52 (e.g., in fluid communication with both the pressure sensor 30 and the barometric pressure port 52). The barometric pressure valve 54 can be configured to selectively permit (e.g., selectively open to permit) fluid communication between the pressure sensor 30 and the barometric pressure port 52. The computing device 1001 can be configured to cause the barometric pressure valve 54 to open (with the main gas supply valve 48 closed) and receive a signal from the pressure sensor 30.

In further aspects, the system can comprise a reference fluid 60 for calibrating the pressure sensor 30. The reference fluid 60 can have a known volume and density. A vessel 62 can contain the reference fluid 60. A reference port 64 can be positioned within the vessel 62 and can be submerged in the reference fluid 60. The conduit 24 can extend between and provides fluid communication between the gas supply 20 and the reference port 64. A reference valve 66 can be fluidly positioned between the pressure sensor 30 and the reference port 64 (e.g., in fluid communication with both the pressure sensor 30 and the reference port 64). The reference valve 66 can be configured to selectively permit (e.g., selectively open to permit) fluid communication between the pressure sensor 30 and the reference port 64.

In some aspects, each port (e.g., the first, second, third, fourth, and reference ports 22, 32, 40, 44, 64) can optionally be defined by an opening at a lower end of a respective tube (e.g., a dip tube). The tubes can be bottom-weighted to urge the lower ends vertically downward.

Each valve (e.g., the first, second, third, fourth, barometric pressure, and reference valves 28, 34, 42, 46, 54, 66) can optionally be a solenoid valve. The valves can be electrically controlled. The valves can be leak-tight miniature air valves. The valves can optionally be mounted to the common manifold.

The system 10 can be configured to periodically take measurements for each tank 12. For example, each tank 12 can be checked once per day, or once per hour. It is contemplated that each tank of the system 10 can be checked at the same intervals as each other tank or at different intervals. It is contemplated that more frequent checking can more rapidly exhaust the gas supply 20.

In some aspects, the pressure sensor 30 can be an absolute pressure sensor. In some aspects, the pressure sensor 30 can be a gauge pressure sensor.

The manifold 26 can optionally be a multiport manifold with integral valve mounting. The manifold 26 can allow termination of field air lines into the manifold.

The system 10 can be adaptable for addition or removal of tanks. Each tank can have from one to four valves associated therewith. At any time, two valves (e.g., the main gas supply valve 48 and a respective port valve) can be operated to take a measurement.

The system 10 can be configured for remote monitoring and control.

In exemplary aspects, the computing device 1001 can be or comprise a programmable logic controller.

The system 10 can be configured to activate an alarm upon detection of water or tank leakage. The system can be configured to detect which tank(s) are being drawn from. The system can be configured to detect blocked air lines and/or leaking air lines. The alarm can comprise one or more of a visual alarm or an audible alarm. The visual alarm can be, for example, an activated error light and/or a display with text detailing the condition (e.g., blocked line, leaking tank, water in tank, etc.).

The system 10 can be configured for use with each tank to accommodate either horizontal or vertical orientation, or any arbitrary tank by entering an ad-hoc level to a volume table.

In exemplary aspects, for one or more tanks, the system 10 can comprise only a first port 22, only first and second ports 22, 32, first, second, and third ports 22, 32, 40, first, second, and fourth ports, 22, 32, 44, only first and third ports 22, 40, only first and fourth ports 22, 44, or any other combination of ports.

### Exemplary Sequence

In an exemplary sequence (in which order can be varied), a barometric pressure can be taken. Accordingly, the main supply gas valve 48 can be closed and the barometric pressure valve 54 can be opened to expose the pressure sensor 30 to the ambient environment via the barometric pressure port 52.

Optionally, a reference pressure can optionally be taken from the reference fluid. For example, the main supply gas valve 48 can be opened, and the reference valve 66 can be opened (with all other valves closed). The pressure sensor 30 can sense the back pressure in the conduit 24, and the computing device 1001 can receive a signal from the pressure sensor.

The main supply gas valve 48 can be opened, and the first port 22 can be opened (with all other valves closed). Gas can be supplied from the gas supply 20 to the first port 22 until no further pressure rise is detected. Upon ceasing supply of gas to the first port 22, the system can wait until pressure is stabilized without flow. The pressure sensor 30 can sense the back pressure in the conduit 24, and the computing device can receive a signal from the pressure sensor. Optionally, the step of opening the first port 22, waiting for pressure to stabilize, and sensing back pressure in the conduit 24 can be repeated.

Supply gas 20 can be delivered to the second, third, and fourth ports 32, 40, 44 in the same manner as described above with the first port 22. In the same manner, supply gas 20 can be delivered to the first, second, third, and fourth ports of each tank 12 of the system.

The system 10 can detect conditions and trigger alarms. For example, pressure rising beyond a first predetermined threshold upon delivery of the supply gas 20 can be indicative of a blocked line. Accordingly, the system can trigger a corresponding alarm. Pressure rising by less than a second predetermined threshold upon delivery of the supply gas 20 can be indicative of an open line (e.g., a disconnect between the conduit between the supply gas 20 and the port). Pressure rising to a threshold only after a predetermined time threshold of delivery of the supply gas 20 can be indicative of a leaking line (e.g., a leak between the conduit between the supply gas 20 and the port).

If the first port 22 is indicated to be blocked, and the second port 32 is indicated not to be blocked, the system can provide an alarm indicating likelihood of ice at the bottom of the tank. The second port 32, also having a known position within the tank, can be used to determine the quantity of liquid 16 in the tank 12.

If the pressure differential between the first and second ports 22, 32 is greater than a threshold, an alarm can indicate water contamination of the tank. It is contemplated that the pressure differential between the first and second ports can be taken after a filling, which is a common event that leads to water contamination.

If the quantity of fuel is decreasing over time without intentional removal, the system 10 can trigger an alarm indicating leaking of the tank.

In some aspects, the computing device can be configured to log a plurality of determined quantities of liquid over time.

### Exemplary Computing Device

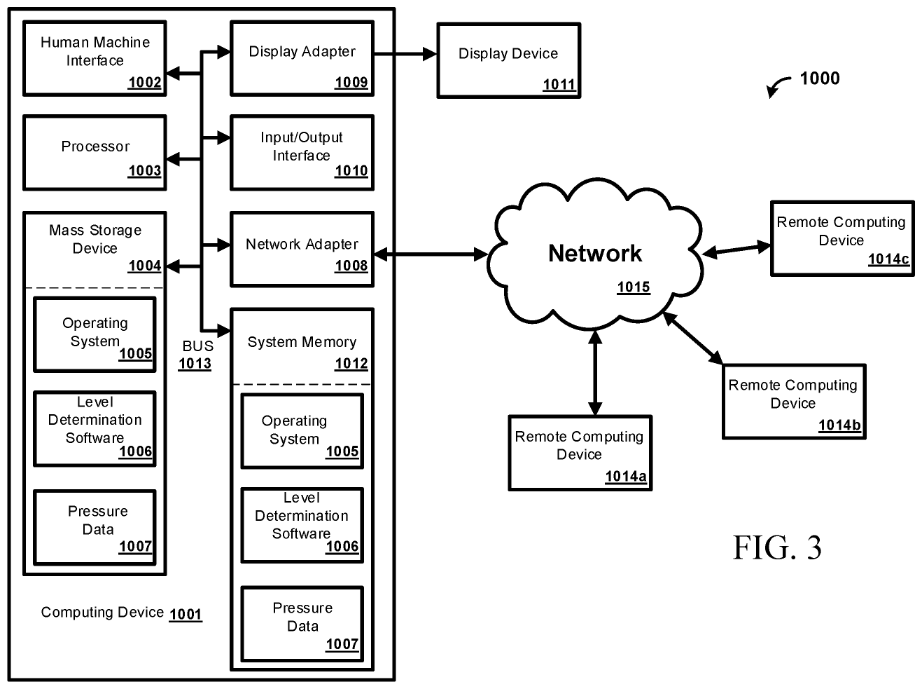

FIG. 3 shows an operating environment 1000 including an exemplary configuration of the computing device 1001 that can be used with the system 10. The computing device 1001 may comprise one or more processors 1003, a system memory 1012, and a bus 1013 that couples various components of the computing device 1001, including the one or more processors 1003, to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as pressure data 1007 and/or program modules such as operating system 1005 and level determination software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and level determination software 1006 may be stored on the mass storage device 1004. One or more of the operating system 1005 and level determination software 1006 (or some combination thereof) may comprise program modules and the level determination software 1006. The pressure data 1007 may also be stored on the mass storage device 1004. The pressure data 1007 may be stored in any of one or more databases known in the art. The databases may be centralized or distributed across multiple locations within the network 1015.

A user may enter commands and information into the computing device 1001 using an input device (not shown). Such input devices comprise, but are not limited to, a keyboard, pointing device (e.g., a computer mouse, remote control), a microphone, a joystick, a scanner, a touchscreen, tactile input devices such as gloves, and other body coverings, motion sensor, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computing device 1001 and a remote computing device 1014a,b,c may be made using a network 1015, such as a local area network (LAN) and/or a general wide area network (WAN). Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. In optional aspects, some or all data processing can be performed via cloud computing on a computing device or system that is remote to the computing device 1001.

Application programs and other executable program components such as the operating system 1005 are shown herein as discrete blocks, although it is recognized that such programs and components may reside at various times in different storage components of the computing device 1001, and are executed by the one or more processors 1003 of the computing device 1001. An implementation of level determination software 1006 may be stored on or sent across some form of computer readable media. Any of the disclosed methods may be performed by processor-executable instructions embodied on computer readable media.

### Advantages of the Disclosed Systems and Methods

The disclosed system can be agnostic to surface foam, pH, conductivity, temperature, turbulence, and solids content. Reliability of the system can be better than other level measurement methods because a port and/or dip tube is the only part of the system in contact with the liquid being measured. The sensor is not in direct contact with liquid, offering long life and greater calibration stability. The instrument panel can be located far from (e.g., optionally, several hundred feet from) what is being measured. The system can be suitable for applications with corrosive, acidic, hazardous, volatile, molten, cryogenic, or radioactive liquids. The supply gas provides complete isolation from the measured liquid. The system can be usable under temperature extremes. The system can be used to detect water and overfills. The system can monitor fuel delivery. The system can be in better compliance with United States Coast Guard and other regulatory requirements than conventional systems.

The system can be used for one or more of the following: accurate inventory control; calculation of generation efficiency; automatic identification of which tank is being drawn down; detection of theft; detection of a slow leak; run-out calculations (when a tank or system is expected to be empty); fuel density calculations; and/or reducing the need to manually stick tanks, thereby improving safety and lowering labor costs.

Although the foregoing invention has been described in some detail by way of illustration and example for purposes of clarity of understanding, certain changes and modifications may be practiced within the scope of the appended claims.

What is claimed is:

1. A system comprising:
at least one tank defining an interior;
a gas supply;
a first port positioned within the interior of each tank of the at least one tank, wherein the first port is in selective fluid communication with the gas supply;
a conduit that extends between and provides fluid communication between the gas supply and the first port;
a first valve fluidly positioned between the gas supply and the first port, wherein the first valve is configured to selectively permit fluid communication between the gas supply and the first port;
a pressure sensor in fluid communication with the conduit; and
a computing device in electronic communication with the pressure sensor and the first valve, wherein the computing device is configured to:
cause the first valve to open,
receive a first signal from the pressure sensor indicative of pressure within the conduit, and
determine a quantity of fluid in the tank based on the first signal from the pressure sensor.

2. The system of claim 1, further comprising:
a second port positioned within the interior of at least one tank of the at least one tank, wherein the second port is in selective fluid communication with the gas supply, wherein the second port is vertically spaced from the first port; and
a second valve fluidly positioned between the gas supply and the second port, wherein the second valve is configured to selectively permit fluid communication between the gas supply and the second port,
wherein the computing device is further configured to:
cause the second valve to open,
receive a second signal from the pressure sensor indicative of pressure within the conduit, and
compare the first and second signals from the pressure sensor to determine a presence of water in the at least one tank of the at least one tank.

3. The system of claim 1, further comprising:
a third port positioned within the interior of at least one tank of the at least one tank, wherein the third port is in selective fluid communication with the gas supply, wherein the third port is vertically spaced from the first port; and
a third valve fluidly positioned between the gas supply and the third port, wherein the third valve is configured to selectively permit fluid communication between the gas supply and the third port,
wherein the computing device is further configured to:
cause the third valve to open,
receive a third signal from the pressure sensor indicative of pressure within the conduit, and
compare the first and third signals from the pressure sensor to determine a density of fluid in the at least one tank of the at least one tank,
wherein the computing device is configured to determine the quantity of fluid in the tank based on the density of the at least one fluid determined by the computing device based on the first and third signals from the pressure sensor.

4. The system of claim 1, further comprising:
a fourth port positioned within the interior of at least one tank of the at least one tank;
a fourth valve fluidly positioned between the pressure sensor and the fourth port, wherein the fourth valve is configured to selectively permit fluid communication between the pressure sensor and the fourth port; and
wherein the computing device is further configured to:
cause the fourth valve to open,
receive a fourth signal from the pressure sensor indicative of pressure within the conduit, and
determine presence of a gas leak based on the fourth signal from the pressure sensor.

5. The system of claim 1, wherein the at least one tank comprises a plurality of tanks.

6. The system of claim 1, wherein the system comprises a plurality of ports, the plurality of ports comprising the first port, wherein the system further comprises a fluid supply valve that is configured to selectively inhibit fluid communication from the supply gas to every port of the plurality of ports.

7. The system of claim 1, wherein the gas supply comprises nitrogen or compressed air.

8. The system of claim 1, further comprising:
a barometric pressure port open to ambient environment; and
a barometric pressure valve fluidly positioned between the pressure sensor and the barometric pressure port, wherein the barometric pressure valve is configured to selectively permit fluid communication between the pressure sensor and the barometric pressure port.

9. The system of claim 1, further comprising:
a vessel containing a reference fluid having a known volume and density;
a reference port positioned within the vessel and submerged within the reference fluid, wherein the conduit extends between and provides fluid communication between the gas supply and the first port; and
a reference valve fluidly positioned between the pressure sensor and the reference port, wherein the reference valve is configured to selectively permit fluid communication between the pressure sensor and the reference port.

10. A method comprising:
supplying, through a conduit, a gas to a first port submerged in a liquid within an interior of a first tank;
receiving a first pressure measurement; and
determining, based on the first pressure measurement, at least one of a quantity of the liquid or an error condition.

11. The method of claim 10, wherein determining, based on the first pressure measurement, the at least one of a quantity of the liquid or an error condition, comprises determining the error condition, wherein the error condition is a pressure above a threshold indicative of a blocked line.

12. The method of claim 10, wherein determining, based on the first pressure measurement, the at least one of a quantity of the liquid or an error condition, comprises determining the error condition, wherein the error condition is a pressure below a threshold indicative of an open line.

13. The method of claim 10, further comprising:
supplying, through the conduit, the gas to a second port submerged in the liquid within the interior of the first tank, wherein the second port is spaced vertically from the first port;
receiving a first pressure measurement; and
determining, based on the first pressure measurement, one of a presence or an absence of water.

14. The method of claim 10, further comprising:
supplying, through the conduit, the gas to a third port submerged in the liquid within the interior of the first tank, wherein the third port is spaced vertically from the first port;
receiving a third pressure measurement; and
determining, based on the first and third pressure measurements, a density of the liquid;
wherein determining, based on the first pressure measurement, the at least one of a quantity of the liquid or an error condition, comprises determining the quantity of liquid, wherein determining the quantity of liquid comprises using the determined density.

15. The method of claim 14, further comprising:
supplying, through the conduit, the gas to a fourth port spaced vertically above the liquid within the interior of the first tank; and
determining a leak in the first tank.

16. The method of claim 15, further comprising activating an alarm indicative of the leak in the tank.

17. The method of claim 10, further comprising:
supplying, through the conduit, the gas to a first port submerged in a liquid within an interior of a second tank;
receiving a fifth pressure measurement; and
determining, based on the fifth pressure measurement, at least one of a quantity of the liquid in the second tank or an error condition.

18. The method of claim 10, further comprising:
receiving a barometric pressure measurement, wherein determining, based on the first pressure measurement, the at least one of a quantity of the liquid or an error condition, comprises determining the quantity of liquid, wherein the determining the quantity of liquid comprises determining a pressure difference between the first pressure and the barometric pressure.

19. The method of claim 10, further comprising:
supplying, through the conduit, the gas to a reference port submerged in a reference liquid within a vessel;
receiving, by a pressure sensor, a pressure measurement; and
calibrating the pressure sensor based on the pressure measurement.

20. A system comprising:
at least one tank defining an interior;
a gas supply;
a first port positioned within the interior of each tank of the at least one tank, wherein the first port is in selective fluid communication with the gas supply;
a conduit that extends between and provides fluid communication between the gas supply and the first port;
a first valve fluidly positioned between the gas supply and the first port, wherein the first valve is configured to selectively permit fluid communication between the gas supply and the first port;
a pressure sensor in fluid communication with the conduit;
a computing device in electronic communication with the pressure sensor and the first valve, wherein the computing device is configured to:
cause the first valve to open,
receive a first signal from the pressure sensor indicative of pressure within the conduit, and
determine a quantity of fluid in the tank based on the first signal from the pressure sensor;
a second port positioned within the interior of at least one tank of the at least one tank, wherein the second port is in selective fluid communication with the gas supply, wherein the second port is vertically spaced from the first port;
a second valve fluidly positioned between the gas supply and the second port, wherein the second valve is configured to selectively permit fluid communication between the gas supply and the second port,
wherein the computing device is further configured to:
cause the second valve to open,
receive a second signal from the pressure sensor indicative of pressure within the conduit, and
compare the first and second signals from the pressure sensor to determine a presence of water in the at least one tank of the at least one tank;
a third port positioned within the interior of at least one tank of the at least one tank, wherein the third port is in selective fluid communication with the gas supply, wherein the third port is vertically spaced from the first port;
a third valve fluidly positioned between the gas supply and the third port, wherein the third valve is configured to selectively permit fluid communication between the gas supply and the third port,
wherein the computing device is further configured to:
cause the third valve to open,
receive a third signal from the pressure sensor indicative of pressure within the conduit, and
compare the first and third signals from the pressure sensor to determine a density of fluid in the at least one tank of the at least one tank,
wherein the computing device is configured to determine the quantity of fluid in the tank based on the density of the at least one fluid determined by the computing device based on the first and third signals from the pressure sensor;
a fourth port positioned within the interior of at least one tank of the at least one tank;
a fourth valve fluidly positioned between the pressure sensor and the fourth port, wherein the fourth valve is configured to selectively permit fluid communication between the pressure sensor and the fourth port;
wherein the computing device is further configured to:
cause the fourth valve to open,
receive a fourth signal from the pressure sensor indicative of pressure within the conduit, and
determine presence of a gas leak based on the fourth signal from the pressure sensor.
